(19) United States
(12) Patent Application Publication
(10) Pub. No.: US 2003/0018557 A1
(43) Pub. Date: Jan. 23, 2003

(54) Financial processing gateway structure

(76) Inventors: James A. Gilbert, Los Angeles, CA (US); Manish Gupta, Tarzana, CA (US)

Correspondence Address: LACASSE & ASSOCIATES, LLC, 1725 DUKE STREET, SUITE 650, ALEXANDRIA, VA, 22314, US

(21) Appl. No.: 10/197,673

(22) Filed: Jul. 18, 2002

Related U.S. Application Data
(60) Provisional application No. 60/305,889, filed on Jul. 18, 2001.

(51) Int. Cl. G06F 17/60

(52) U.S. Cl. 705/36

(57) ABSTRACT

A web-based system for the management of various types of retirement plans including 401(k) plans, money purchase plans, and profit sharing plans is described. The system comprises: (a) a computer-based retirement system such as a 401(k) system; (b) a plan provider gateway providing plan providers (banks, brokerages, insurance companies, payroll services, etc.) with access to the 401(k) system; (c) a plan sponsor gateway providing plan sponsors (such as individual companies that offer 401(k) to their employees) and authorized plan provider representatives with access to the 401(k) system; and (d) a plan participant gateway providing plan participants (such as individuals participating in a 401(k) plan), authorized plan provider representatives, and authorized plan sponsor representatives with access to the 401(k) system. Thus, each type of user (a plan provider, a plan sponsor, or a plan participant) is able to perform their appropriate and necessary functions via the above-mentioned three gateways.

### CROSS-REFERENCE TO OTHER APPLICATIONS

The present application claims the benefit of provisional patent application “Select Administrator Software Specifications”, serial No. 60/305,889, filed Jul. 18, 2001.

### BACKGROUND OF THE INVENTION

1. Field of Invention

The present invention relates generally to the field of management of financial funds. More specifically, the present invention is related to online management of retirement funds.

2. Discussion of Prior Aft

401(k) plans are arguably the best government-sanctioned, tax-deferred retirement savings opportunities in the United States, and their numbers have grown commensurably since their institution by Congress in 1978. One estimate, by CHALK 401(k) Advisory Board, Inc., places the number of qualified 401(k) plans in 1997 (the last year surveyed) at 225,000, and the number of participants in those plans at approximately 28 million. The Investment Company Institute (ICI) estimated 36.7 million participants in 1998. New plans continue to grow in number at an annual rate of more than 14% (Source: U.S. Department of Labor).

However, 401(k) plans must be sponsored by an employer. Millions of American workers can't take advantage of a 401(k)s many attractive attributes because, for one reason or another (typically high plan costs, plan inflexibility, and/or prohibitive minimum participation standards), their employers do not sponsor such a plan. In particular, very small (including “micro” companies), small, and medium-sized companies have found sponsorship difficult, if not impossible. Eighty-nine percent of very small companies (10-50 employees), 72% of small companies (50-100 employees), and 66% of medium-sized companies (100-250 employees) do not have 401(k) plans (Source: Census Bureau). It should be noted that these figures do not include the companies that have fewer than 10 employees—what might be called “micro” companies.

With regard to the desirability of employer offered benefits, employees rank 401(k) plans second only to health benefits when it comes to employer-offered benefits they desire. 401(k)s offer employees an unmatched long-term savings potential—primarily because neither 401(k) contributions nor their earnings are subject to income tax withholding during plan participants' pre-retirement years.

This tax deferral has a huge compounding effect: $150 per month put into a typical taxable savings account paying 8% annual interest will grow to $42,034 by the end of 20 years (assuming a combined federal and state personal income tax rate of 34%). In a 401(k), however, the same deposits earning the same rate of return during the same 20 years will yield $88,353. Even if that amount is taxed at the 34% rate when the money is withdrawn from the plan (which is unlikely if the participant is retired), the 401(k) participant will walk away with more than $16,000 compared to the typical equivalent non-401 (k) investment return.

401(k) plans have the highest annual contribution ceiling of any tax-deferred savings program (including IRAs, SEPs, etc.). Higher contributed amounts equal more money earning money—which equates to more money in the account 20 years later. Added to this earning potential is the convenience of using automatic payroll deductions. For the foregoing, it's easy to see why 401(k)s are so popular.

The non-profit Investment Company Institute (ICI), the trade association of the mutual fund industry, estimates that, at the end of 1998, assets in 401(k) plans stood at $1.41 trillion. These plan assets grew an average rate of 18% per year during the 1990s. Plansponsor.com reports that assets rose nearly 22% in the final year of the decade, from $1.7 trillion in 1999 to $2.1 trillion in 2000.

Average salary deferral rates of plan participants have also been on an exponential rise. The non-profit Profit Sharing 401(k) Council of America (PSCA) reports that the average salary deferral rate grew from 4.2% in 1991 to 5.4% by 1999—an increase of more than 28%.

According to the ICI and the non-profit Employee Benefit Research Institute, the average account balance at the end of 1998 was $47,000 per participant, up 26% from 1996. On average, 78% of eligible employees will participate in a 401(k) plan if one is made available, with the number of participants growing from 19.5 million in 1990 to 53.2 million in 2000.

Some of the increase in participation rates is due to the introduction of “negative election,” which allows an employer to automatically enroll employees into its 401(k) when employees meet the plan's eligibility requirements. The negative election deferral rate and investment(s) must be defined ahead of time, and the employee must be immediately notified of his or her participation status. Automatic enrollment programs are sanctioned by the IRS under the Employment Retirement Income Security Act (ERISA) as long as the employee has ample ability to cease enrollment at will.

A constraint on 401(k) growth is the fact that 401(k) plans must be sponsored by an employer and contributions must be subtracted from the employee's pay within the payroll process before income tax withholding is calculated. Due largely to misinformation about the complexity of running a 401(k), coupled with a general fear of the IRS and the Department of Labor (both of which have regulatory power over the plans), many employers have excluded this popular benefit from their employee benefits package. This is especially true of very small (including micro), small, and medium-sized companies.

For many small and medium-sized companies that do have 401(k)s, the plans' futures are bleak: many are being canceled because they are not profitable enough a service for vendors to maintain; in other cases, service is not being canceled but the level of service is so disproportionate to the high fees being charged that employers themselves must pull out or endure the aggravation of continually feeling as if they are being over-charged. As an estimate, it is believed that there are more than 400,000 very small (including micro companies), small, and medium-sized companies that: (a) have no plan, (b) have had their plan canceled or have canceled their plan, or (c) have a plan with which they are unsatisfied.

Traditional 401(k) plan vendors did not think much about approaching smaller companies until recently, and then did so only because they recognized that the larger-company market was pretty well saturated. When they did turn their attention to the smaller and mid-sized plan market, they were well prepared, with a library of useful educational materials for potential and actual plan participants.

Unfortunately, however, these vendors were not as equally prepared to service the needs of the smaller companies: the plans they designed and the packages they offered were not always appropriate in price, substance, or style; and their pamphlets and publications have often been too dry, legalistic, and expensive. Perhaps because most of these vendors are large companies themselves, they have difficulty conceiving 401(k) plans that embody the entrepreneurial, “do-ityourself” spirit so prevalent in many small and medium-sized companies.

Thus, there is a need for high-quality, affordable 401(k) plans for small and medium-sized companies; i.e., plans that would:

accommodate any number of participants;

offer a wide selection of SEC-regulated mutual fund investment options and self-directed brokerage accounts;

allow multiple families of mutual funds within a single plan;

provide a full range of 401(k) features such as employer-matching contributions, monthly participant account statements, loans, and hardship withdrawals; and

provide a computer network structure to enable 24/7 access to all parties involved in the 401(k) plan.

U.S. Pat. No. 6,041,313, assigned to the applicant, teaches the use of individual participant accounts rather than a pooling of employees' contributions in a single omnibus mutual fund account.

In 1997, the applicant began development of a new generation of 401(k)-administration software, to be called 401(k) Easy™. 401(k) Easy, delivered to adopting employers on CDROM, is a Windows®-based, complete 401(k) set-up and administration system designed to run on an employer's in-house computer system. 401(k) Easy is highly automated and designed for easy operation by non-professionals. Since the plan sponsor runs the company's plan “in-house,” the need to hire and retain an outside third-party administrator (TPA) is eliminated. By eliminating the TPA, the plan sponsor can expect a savings of up to 90% off the traditional cost of providing a 401(k) to company employees. 401(k) Easy software is simple to use and inexpensive to license, so primary obstacles that small businesses face when offering a 401(k)—high cost and operational complexity—have been eliminated. The “run-it-yourself” approach so popular today with small businesses in addressing tasks such as payroll and bookkeeping has proven to be equally well suited to the routine task of 401(k) plan administration.

The invention relies substantially on the speed, efficiencies, and information mobility inherent on the Internet. Internet penetration and usage by small business is a key component of the present invention. According to a survey conducted by the International Data Corporation (IDC), Internet usage by small business reached 62% in 1998. Total small business spending on Internet-related applications is expected to increase from $6.6 billion in 1998 to 418.2 billion by the end of 2002, yielding an annual growth rate of 45%.

The following references provide for a general description of various systems that provide financial access to various funds. It should, however, be noted that the prior art systems fail to disclose a gateway-based system for real-time management of retirement funds.

The Harris U.S. Pat. No. 5,517,406, assigned to The Shareholder Services Group, Inc., provides a method and apparatus for data verification and position reporting in an automated trade transaction processing system. The system also includes a record keeper for receiving participant mutual fund transaction requests and a record keeper that aggregates the participant mutual fund transaction requests by mutual funds into omnibus plan transaction requests.

The Jennings U.S. Pat. No. 5,659,165, assigned to Citibank N.A., provides for a customer-directed, automated process for transferring funds between accounts via a communication network. The system automatically computes the appropriate exchange rates and any fees to be charges to the account and displays them to the user so that the user may authorize or cancel a transaction. Additionally, the system is provided with various safeguards to assure that only authorized individuals have access to accounts and the funds and immediately verifies successful completion or failure to the customer.

The Campbell U.S. Pat. No. 5,749,077, assigned to FS Holding, Inc., provides for a method and apparatus for updating and selectively accessing financial records related to investments. In the preferred approach, for selected categories of information, the user may elect one of three options as to each screen field to obtain rapid, customized information delivery.

The Funk U.S. Pat. No. 5,793,497, assigned to Infobeat, Inc., provides for a method and apparatus for delivering and modifying information electronically from one or more information sources such as a stock exchange.

The Hackel U.S. Pat. No. 5,806,047, assigned to Metlife Life Insurance Company, provides for a system for combined pool portfolio. The disclosed system allows pension plans and individuals' pension accounts which own employer securities to transfer the employer securities into a combined pool.

The Wilson U.S. Pat. No. 5,864,827, assigned to Belzberg Financial Markets and News International, Inc., provides a system and method for providing an information gateway, wherein the gateway allows the transfer of information between financial markets and customers.

The Maggioncalda U.S. Pat. No. 5,918,217, assigned to Financial Engines, Inc., provides a user interface for an advisory system. Disclosed is a user interface for a financial advisory system, which provides a user with an interactive method of exploring how changes in one or more input decisions such as a risk tolerance, a savings level, and a retirement age affect one or more output values such as a probability of achieving a financial goal or an indication of short-term risk.

The Harris U.S. Pat. No. 5,918,218, assigned to First Data Investor Services Group, Inc., provides for a method and apparatus for automated trade transactions processing. In the disclosed system, a record keeping system aggregates the participants mutual fund transactions into omnibus plan trades which is then transmitted to a host processor.

The Debe U.S. Pat. No. 5,983,204, assigned to Americus Shareowner Service Corp., provides a system and method for supporting a new financial instrument for use in closed end funds. Disclosed is a data processing system to effectuate all transactions pertaining to PREPs (Put Ratio Equity Protection) and the creation of PREP certificates.

The Williams U.S. Pat. No. 5,999,918, assigned to Rational Investors, Inc., provides for interactive color confidence indicators for statistical data. Disclosed is a computer interface system (virtual investment advisor) that includes interactive interface controls as well as aural and kinetic interface controls to assist in educating a user, in profiling a user, and in controlling and monitoring the implementation of actions involving investments. In addition, the user is able to manipulate the interface controls to evaluate results in terms of confidence and risk, and upon approval, may transmit selections to effectuate an action.

The Ferguson U.S. Pat. No. 6,064,984, assigned to MarketKnowledge, Inc., provides for a graphical user interface for a computer-implemented financial planning tool. Disclosed is a computer-implemented method for financial planning, which may provide a display framework in conjunction with a repository of information about financial products for the purpose of creating an on-line financial plan. In addition, the method provides a computer-implemented method of financial planning to be used by a broker and a customer together in an interactive manner.

The Edelman U.S. Pat. No. 6,064,986, assigned to Edelman Financial Services, Inc., provides for a computer assisted and/or implemented architecture for customer account creation, maintenance and administration for an investment and/or retirement program. The U.S. Pat. No. 6,085,174, also to the same assignee, provides a computer product for instructing a computer to perform a process of administering in the administration of resources of a customer for the benefit of a beneficiary.

The Schoen U.S. Pat. No. 6,235,176, assigned to MB Schoen and Associates, provides for a computer apparatus and method for defined contribution and profit sharing pension and disability plan.

The published patent application to Calver (US 2001/0032092 A1) discloses a small business web-based portal method and system for interactively providing user-tailored financial and business information based upon user-provided financial and business information.

The published patent application to Kelly et al. (US 2001/0037276 A1) provides a system and method for group retirement plan administration. The disclosed method provides group retirement services to one or more sponsors, wherein at least one sponsor has one or more participants enrolled in a retirement plan.

Whatever the precise merits, features and advantages of the above cited references, none of them achieve or fulfill the purposes of the present invention.

### SUMMARY OF THE INVENTION

The present invention provides for a web-based system for the management of various types of retirement plans, including: 401(k) plans, money purchase plans, and profit sharing plans. The system comprises: (a) a computer-based 401(k) system; (b) a plan provider gateway providing plan providers (banks, brokerages, insurance companies, payroll services, etc.) with access to a 401(k) system; (c) a plan sponsor gateway providing plan sponsors (such as individual companies that offer 401(k) to their employees) with access to a 401(k) system; and (d) a plan participant gateway providing plan participants (such as individuals participating in a 401(k) plan) with access to a 401(k) system. Thus, each type of user (a plan provider, plan sponsor, or plan participant) is able to perform his/her appropriate and necessary functions via the above-mentioned three gateways.

The plan provider gateway allows plan providers to approve and modify client and plan settings, process plan corrections and adjustments, review the audit trail, suspend a plan's operation, maintain the offered spectrum of investments, process and distribute investment income and dividends, perform general system maintenance, perform any plan maintenance activities, as well as other essential plan provider functions. The plan sponsor gateway, on the other hand, provides the plan sponsor with a pathway to the 401(k) system, with the functions associated with this gateway separated into various streams: plan configuration (which controls overall plan information and operation parameters), day-to-day plan administration functions (which power and monitor day-to-day administrative activity), as well as other essential plan sponsor functions. Lastly, the plan participant gateway allows a participant to perform various functions, such as (but not limited to); updating information; updating investment designations; monitoring; modeling; applying for loans, transfers, and distributions; as well as other essential plan participant functions.

The present invention's online system is accessible 24/7 from any industry-standard web browser, allowing “anywhere, anytime” to all users. It should be noted that the web-based system is able to accommodate any number of plans with any number of participants.

Additionally, the present invention's system enables small business users operating on Unix®, Windows®, Macintosh®, or any platform to access their plan account information readily, cost effectively, and efficiently. The on-line solution offers users access to their personal records from anywhere Internet access is provided. This could be from the privacy of their homes to local libraries or from their desks at work. More control and information at the end-user level will enable employees to become more involved in investing increasing levels. The momentum of the Internet will offer plan providers (banks brokerage firms, mutual funds managers, and other organizations that manage retirement plan assets) the opportunity to gain a greater share of the employees' assets. This also leads to increased opportunity for financial institutions and brokers to offer additional related products to a growing client base. The present invention's system and method provides a significant advancement over prior art systems and methods in several key areas, some of which are outlined below:

It replaces a multitude of third-party administrative, labor-intensive processes with intuitive, fully automated processes.

It offers plan providers the ability to set up an unlimited number of new plans quickly and offer in each new plan custom features pertinent to the objectives of each new plan sponsor.

The invention offers plan sponsors the first web-based “run-it-yourself” 401(k)” including enabling the plan sponsor to monitor and actively manage the company's 401(k) plan in-house, in real time, from the convenience of any Internet browser.

The invention enables efficiency through automation and a new standard in convenience through Internet deployment. The invention is the first enterprise-level 401(k)-plan administration system that can be operated by non-professionals and at a fraction of the cost and time that traditional pension professionals devote using prior art.

### BRIEF DESCRIPTION OF THE DRAWINGS

FIG. 1 illustrates the present invention's web-based system accessible by three types of users: plan providers, plan sponsors, and plan participants.

FIG. 2 summarizes the interaction between various entities and gateways of the present invention.

FIG. 3 illustrates a three-tier implementation (web/user interface tier, server-based mid tier, and database tier) of a system based upon the present invention.

FIG. 4 illustrates a flowchart depicting the routine sequence of events associated with the present invention's 401(k) system.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Furthermore, the terms “end user”, “user”, “participant”, “customer”, and “employee” are used interchangeably throughout the specification, and therefore should not be used to limit the scope of the present invention.

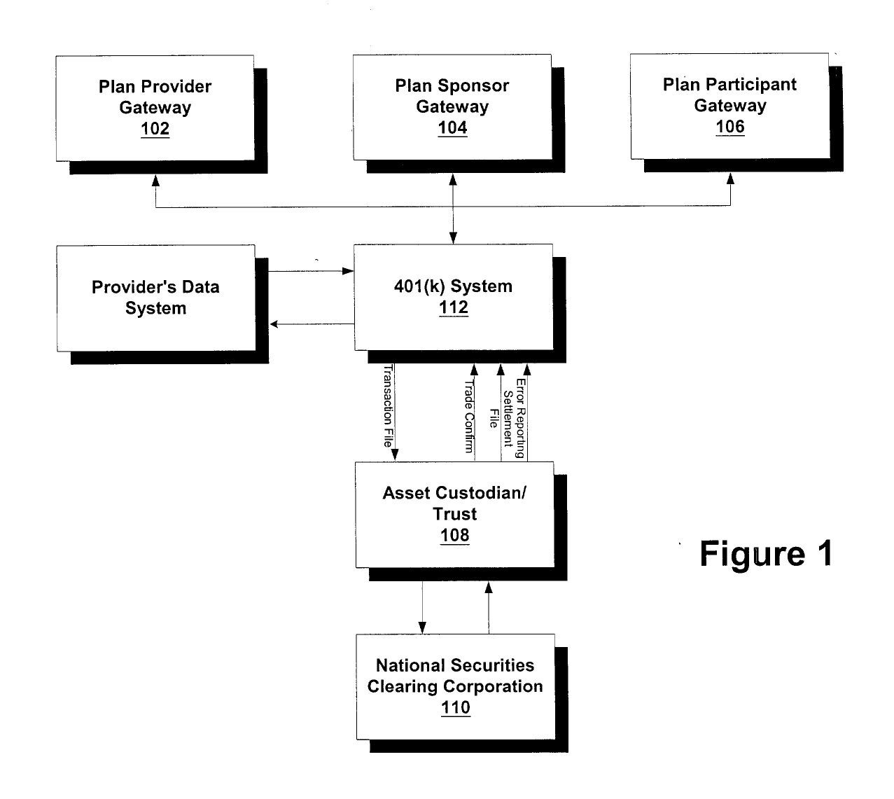

FIG. 1 illustrates the present invention's web-based system accessible by three types of users: plan providers (banks, brokerages, insurance companies, payroll services, etc.); plan sponsors (individual companies that offer 401(k) to their employees); and plan participants. Each type of user has the ability to perform his/her appropriate and necessary functions via three user-defined gateways: plan provider gateway 102, plan sponsor gateway 104, and plan participant gateway 106.

The asset custodian/trust 108 connects the plan provider with real-time access to mutual fund shares and other investments, and their valuation. Asset custodian/trust companies 108 are members of the National Securities Clearing Corporation 110 and as members, connect plan providers with access, trading and reconciliation services for thousands of investments, including all mutual fund groups registered with the Security Exchange Commission (SEC). The custodian/trust trading and accounting systems provide plan providers with a seamless package of daily pricing, cash movements and position files. All this real-time investments and mutual fund share trade, reconciliation and pricing information is available to the 401(k) software system electronically via a customizable interface, that is reliable, fast and secure.

The National Securities Clearing Corporation (NSCC) 110 is the nation's leading provider of centralized clearance, settlement and information services to more than 2,500 brokers, dealers, banks, mutual funds, insurance carriers and other financial intermediaries. The NSCC 110 develops standardized, automated solutions that promote connectivity, efficiency and lower risk in the financial services marketplace. The NSCC 110 provides the following key services to the Asset Custodian 108:

The NSCC 110 manages all processing and settling of investments and also mutual fund shares for all the nation's fund groups. The service provides standardized formats and centralized processing of purchase, redemption, and exchange orders, account registrations, and provides participants with a single daily net settlement.

Commission settlement for investments and mutual fund transactions are managed by the NSCC 110 using a standard format in its centralized processing environment. The commission settlement service supports all types of investment and fund commissions including Contingent Deferred Sales Charge (CDSC) payouts, 12b-1 fees (or trail commissions), or other types of payments.

The NSCC's Mutual Fund Profile Service automates the flow of information between NSCC participants in a centralized system, using standardized formats. Share Price and Rate files report daily Net Asset Value (NAV) and daily distribution rates for individual mutual funds for a specific date.

The NSCC 110 also maintains an automated, centralized record-keeping system through which all customer account activities can be exchanged by participants. The service provides accurate, timely updates in a controlled environment. A standard format uniformly reports account positions, activity and dividend information, as well as registration updates between investment companies, or their transfer agents and financial intermediaries. Investment and mutual fund dividends may be settled through NSCC's net settlement option.

Thus, in summary, plan provider's 401(k) software 112 creates a transaction file (for purchase and redemption orders) and uploads the transaction file to the asset custodian/Trust 108. Next, the asset custodian/trust 108 submits the plan provider's trades in the plan provider's transaction file to the NSCC 110. The NSCC 110 transacts and confirms the trades and returns a settlement file to the asset custodian/trust 108. Finally, the asset custodian/trust 108 electronically transmits the trade data to the 401(k) software's recordkeeping system to support the daily reconciliation and pricing needs of the plan provider. In the event any errors are identified by the asset custodian/trust 108, they are reported to the 401(k) system 112.

Plan Provider Gateway 102

The plan provider gateway allows personnel of a financial intermediary the ability to:

Perform any plan maintenance activities available through the plan sponsor gateway.

Approve and modify client and plan settings, including: general information, fee structure, and available investments/fund choices.

Process plan corrections and adjustments.

Review the “audit trail” of all transactions and the activity for each plan.

Activate/Suspend a plan's operation.

Maintain the offered spectrum of investments/funds.

Process and distribute investment income and dividends.

Perform general system maintenance activities and review system logs.

Perform all plan maintenance activities available through the plan participant gateway.

Set-up and maintain transaction billing fees (i.e. loan fees, distribution fees, asset transfer fees, etc.) assigned to each plan sponsor, and generate invoices.

Activate, deactivate and manage internal e-mail notification system between plan providers, plan sponsors and plan participants.

The present invention's intuitive configuration controls enable the provider's authorized personnel to navigate and update system settings. Functions pertain to:

Users: The plan provider can add, delete, and modify the security privileges of its authorized customer service and back-office personnel.

Investments: The present invention allows maintenance of the spectrum of investments offered by the provider. Investments appear within each client's plan sponsor gateway and plan participant gateway according to the subset of investments the client selects for its plan. Investment data includes, among other fields: investment name, investment type, abbreviation, ticker symbol, cusip, fund number, daily net asset value (editable by provider), daily accrual factors (editable by provider), and income posted to each investment (editable by provider but validated against the asset custodian's records).

Prototype Plan: The provider can have the present invention's prototype plan configuration wizard operates in conjunction with an IRS-approved prototype plan document and adoption agreement wherein these two pre-approved documents reduce the IRS user fee(s) paid by the plan sponsor, eliminates IRS requests for minor plan corrections, ease compliance with the continual plan updates, and minimizes the continual plan update process, thereby reducing plan sponsor's costs (in addition, the pre-approved plan documents allow a plan sponsor in most cases to avoid the IRS determination letter process).

or the provider can have the wizard operate in conjunction with any other vendor's plan documents.

General: The present invention includes system activation/deactivation, archival period, and setting of batch transmittal times.

Within the system's client and plan management functions, the provider's authorized personnel can:

View a list of all plans in the system.

Review and update plan information, including: settings, activity, fees, pending transactions, corrections, and adjustments thereof.

Jump to plan administration for a selected client's plan, with automatic entry through the plan sponsor gateway, if security privileges so authorize.

View and update client information.

Review plans submitted through the plan setup wizard, review items with the client as needed, then approve or decline the plan for acceptance into the system.

Generate plan documents by having the system export relevant client and plan data, as captured by the plan setup wizard (export file layout keyed to provider's prototype plan document system), with documents transmitted to the client for approval, then the provider's representative can open the plan-specific plan sponsor and plan participation gateways.

View and apply detailed histories of plan activity, including contributions, liquidations, transfers, and distributions (plan activity is listed as current or archived, depending on appropriate factors and choices made during processing).

Establish, review, and update fee activity for client's plan(s). Fees can be processed through a predefined payment algorithm (algorithm used to determine which investments are liquidated to satisfy payment of fee), as defined by provider, and fee information can be exported to provider's fee processing center, if any.

View and act upon pending transactions for the specified plan, as listed in the “Pending Transactions” panel and provider representatives can review transaction details (participant name, plan name, transaction type/description, etc.), note why a transaction is pending, and, if desired, release the pending transaction for processing or cancel it (a transaction might be pending, for example, because receipt of money by the trust system cannot be verified though the asset custodian interfaces).

View and organize activity via the plan audit log. Information can be sorted by date, range, user, participant name, transaction type, investment name or type, and/or source.

Make corrective entries via the corrections/adjustments panels. The system calculates adjustment amounts for the user based on the corrections, and the service representative can then choose to post or override the adjustments.

Access and use any plan administration functions available through the client's plan sponsor gateway.

The global audit log maintains a record of all activity performed throughout the system, including activities at the general system administration level. The provider's personnel can search for information by client, plan, date range, plan administrator, participant, and/or transaction type.

Plan Sponsor Gateway 104

The plan sponsor gateway is a plan sponsor's pathway to the 401(k) system's plan administration functions. It is accessible to both authorized provider representatives as well as, to the degree that the plan is a self-service 401(k), authorized plan sponsor personnel. For instance, in fully self-service plans, all plan administration functions are active and accessible to authorized plan sponsor personnel; whereas in more full-service plans—ones in which the client is paying the provider to handle the plan's administration—either the entire gateway is hidden to anyone but the authorized provider representatives, or perhaps just one or two of the most basic communication functions—such as fees and configure bulletins—are apparent to authorized plan sponsor personnel. It should be noted that access to the 401(k) system's plan administration is user-name and password protected. Functions are separated into two streams: (1) plan configuration functions, which control overall plan information and operation parameters; and (2) day-to-day plan administration functions, which power and monitor day-to-day administrative activity.

The 401(k) system's plan configuration wizard enables a plan sponsor, with or without the help of the licensed provider, to customize its 401(k) plan within the options allowed within the IRS-approved prototype plan that the licensed provider has chosen to employ (go to system provider gateway, system configuration functions for details on the licensed provider's prototype plan options). Data collected by the wizard is transmitted to the licensed provider in a format conducive to speedy and accurate production of necessary documents and collateral materials.

The plan sponsor gateway provides all functionality necessary for the subscribing employer to:

Configure Client: Allows authorized user(s) to view and edit the company's name, address, tax ID number(s), etc., to be associated with the selected plan, as well as to establish log-in names and passwords authorizing the entry to a plan's day-to-day administration functions. Thus, authorized user(s) are able to set up and maintain company information, divisions, employee records, etc.;

Configure Bulletins: Enables authorized user(s) to create bulletins that will be visible to each employee as they log into the system;

Configure Divisions: Enables authorized user(s) to create and modify divisions to attach to employee data. Common division categories include branch office locations and company departments (i.e., accounting, marketing, etc.);

Configure Employees: Enables authorized user(s) to access the list of fees the provider service representative has posted to the plan sponsor's account. If the plan sponsor has more than one plan, fees are categorized by application plan.

Day-to-Day Plan Administration Functions

401(k) system's day-to-day plan administration functions include:

Plans: The ability to view and edit (as appropriate) a list of the plan sponsor's existing plan(s) with the provider and to model a new plan, if desired, for approval submission to a provider service representative.

Transaction Log: Displays a list of transactions for the currently selected plan as well as the status of each transaction (pending, held, settled, etc.).

Participants: Leads into the main participant activity functions for the selected plan. The initial panel displays a list of plan participants and links to the plan participant gateway for access to direct management of employees' accounts, including loan, transfer, and distribution activity.

Investments: Displays the investments (including self-directed brokerage accounts, if any) currently offered within the selected plan. Investments can be any subset (including the complete set) of investments the provider has chosen to have its licensed 401(k) system offer its 401(k) clients.

Process Contributions: Allows the authorized user(s) to process regular as well as “special” contributions, such as transfers from a previous employer's 401(k) plan. Contribution payroll information can be uploaded from a text file directly into the processing grid. The system will perform automatic validation checking and report any errors or rule violations encountered in the data. The authorized user(s) can do all plan processing at once or save data and continue later. In self-service plans, once data is submitted for processing, it is held by the system until verification of funds is received through the asset custodian or released by a provider service representative.

Set up and maintain multiple concurrent plans.

Define fund availability within each plan.

Process, approve, and administer plan activity including contributions, distributions, transfers, and loans.

Generate activity reports, forms, and statements.

Review fees and charges.

Enter company-wide bulletins for employees.

Perform compliance testing, including: 402(g), 401(k), 401(m), 415, multiple use test, top heavy test, coverage test, and compensation test.

Determine the vesting percentage for each plan participant using the vesting calculator function.

Participant Loans, Transfers, and Distributions: Accessed through the plan participant gateway, the loans, transfers and distributions panel displays a list of pending loan, distribution, and transfer requests submitted by plan participants. Authorized plan administration user(s) can approve or deny the requests and can model new loans, distributions, and transfers for plan participants.

In addition, authorized plan administration user(s) can key in loan payoffs, partial payoffs, and re-amortizations. In the case of payoffs or partial payoffs within self-service plans, transactions remain in “pending” status until verification of funds is received from the asset custodian or until specifically released by an authorized provider service representative.

Activity: Accessed through the plan participant gateway, the activity panel displays a detailed list of buy/sell activity for all participants of the selected plan. Data can be filtered by date range, participant, investment name, and source.

In self-service plans, authorized plan sponsor personnel handle all of the above. In full-service plans, provider representatives run these day-to-day administration functions.

The present invention enables viewing and printing forms related to the activity in the plan. Forms include, among many others, enrollment, loan request, and request for investment statements being sent to more than one address.

The present invention enables viewing, printing, and generating any of a variety of administration reports, including: contribution statements for participants, allocation logs, and ERISA 404c compliance logs (which list, among other things, fulfillment of information requests to eligible employees).

In self-service plans, the authorized plan sponsor can access and generate the above. In full-service plans, the provider representatives take charge.

Plan Participant Gateway 106

401(k) system empowers plan participants to serve themselves—at any time, day or night, from any location connected to the Internet—to their 401k account activity and information.

401(k) system's self-service plan participation gives eligible employees on-the-spot access to enrolling in the plan, updating personal information and investment designations, viewing/printing activity reports and account statements, and 401(k) loan, transfer and distribution modeling and/or new submissions, among other things.

Self-service plan participation is extremely convenient for plan participants and can greatly boost plan participation rates.

Self-service plan participation means far less work for the plan administrator (whether that administrator is the plan sponsor, in the case of self-service plans, or provider personnel, in the case of full-service plans).

Self-service plan participation means the licensed provider can stay completely out of day-today plan participation activity and yet monitor and/or get involved in activity at any time.

Self-service plan participation is assisted by the inclusion of context-sensitive help—information, explanations, and simple instructions for the user—available to the user on every plan participant screen.

Self-service plan participation means the plan participant never has to involve the plan sponsor in routine information requests for printed investment history or current balance information. The plan participant can call-up and print reports and a personal account statement directly from the screen.

The 401(k) system creates a home page for each plan participant. Upon login, the participant arrives at the home page, which welcomes the participant to the system's self-service plan participation functions and, subject to the provider's and/or plan sponsor's desire, shows the participant's investment designations, account balances, recent account activity, etc. Any current internally generated e-mail bulletins the plan sponsor and/or provider have created via the internal 401(k) e-mail system are also displayed on each participant's home page.

Plan participants never have to involve the plan administrator (whether that administrator is the plan sponsor, in the case of self-service plans, or provider personnel, in the case of full-service plans) in routine account information updates.

Plan participants update personal information themselves, online, at their leisure.

Participants can amend their address, telephone number(s), disbursement preferences, passwords, and more. The 401(k) system immediately notifies the designated plan administrator via e-mail of any changes.

The provider and, at the provider's discretion, the plan sponsor can elect to mandate that the designated plan administrator approve changes before they become effective. (Unless the plan is fairly small, however, such is not recommended, as it can become too time-consuming for the plan administrator.)

Plan participants never have to go through their designated plan administrator (whether that administrator is the plan sponsor, in the case of self-service plans, or provider personnel, in the case of full-service plans) to access and/or amend their salary deferral rates and/or their investment designations.

The 401(k) system displays for the participant all available plan investments and indicates those to which the participant is contributing and at what rates.

The 401(k) system also gives the participant options for amending his/her designations.

The licensed provider or, at the provider's discretion, the plan sponsor can elect to mandate that the designated plan administrator approve changes before they become effective.

All investment and salary deferral designations are restricted within the 401(k) system by rates allowable under the current federal law.

In addition, the provider can impose restrictions on investing, such as monthly minimums per investment; any such restrictions are incorporated into the provider's 401(k) system and applied to all relevant functions within all gateways.

Any changes the provider chooses to make to such restrictions are easily communicated to plan participants via the 401(k) system bulletins functions.

Plan participants never have to go through their designated plan administrator for transaction information (on existing loans, transfers, distributions, etc.). Instead, participants simply go online and access the information themselves. Participants are able to monitor, model, and apply for loans, transfers, distributions, and print statements and reports concerning their personal 401(k) accounts.

In addition, participants considering a new loan, transfer, or distribution can have the 401(k) system model the effect of such on their 401(k) account:

During the modeling process, the 401(k) system calculates the availability of funds based on money sources, aged buckets (if applicable), and other applicable rules.

To accept a new loan, transfer, or distribution, the participant must correctly answer one of his or her “secret” questions that the employee established when setting up his or her log-in name and password (see below).

New loans, distributions, and transfers must be approved by the designated plan administrator and are indicated as “pending” until so approved.

The 401(k) system gathers the information the designated plan administrator needs to approve or deny an application.

The provider (or at provider's discretion, the plan sponsor) can have the 401(k) system decline any new submission for loans, transfers, or distributions if an application for such is already in the system as “pending” approval of the designated plan administrator. This works as a safeguard against plan participants flooding the system with applications for the same transaction while the plan administrator awaits, for example, a spousal content.

Within the loans, transfers, and distributions panel, the participant also has the option to download and/or print necessary forms to request loans, distributions, and transfers in person from the designated plan administrator and to manually perform other related account maintenance activities.

Plan participants enter the plan participation gateway by keying in the user name and password they established during their first visit.

The designated plan administrator (whether the plan sponsor, in the case of self-service plans, or provider personnel, in the case of full-service plans) issues a temporary password for that first visit to allow an employee entrance into the system.

Eligible employees not currently enrolled in the plan can easily be granted temporary passwords by the designated plan administrator so that they can discover how easy saving money via the company's online 401(k) plan can be.

When establishing their user name and password, plan participants also establish three identifying questions and answers, such as to “mother's maiden name”. These questions are later used to confirm the participant's identity when the participant, for instance, applies for a 401(k) loan or forgets his/her password.

The 401(k) system houses a complete log of each employee's user name, password, and three questions/answers within the plan sponsor gateway (which is also accessible to authorized provider personnel); plan participants can request help from the designated plan administrator (via the 401(k) system, in person, by phone, etc.) at any time.

Self-service equates to low overhead for the provider and marketability to plan sponsors. With the 401(k) system, plan participation is self-service.

Self-service plan participation means participants can access their 401(k) accounts anytime from anywhere. This flexibility makes the 401(k) system plans highly popular with plan participants, and thus highly marketable to plan sponsors.

The 401(k) system allows the licensed provider the flexibility of promoting its self-service plan participation with both full-service (i.e., administration handled via the 401(k) system by the provider) and self-service (administration handled via the 401(k) system by the plan sponsor) 401(k) plans with very low overhead on the service.

The 401(k) system's self-service plan participation means that whoever (be it plan sponsor or licensed provider) is using the 401(k) system to run the 401(k) plan is freed from numerous tasks such as fulfilling participant requests for enrollment, information, forms, address updates, and more.

The 401(k) system's self-service plan participation means the licensed provider can have the system pre-programmed to access all information a participant is likely to request—including investment information and prospectuses—thus completely freeing the provider from day-to-day participation activities (but always with complete oversight capabilities of those activities).

Self-service plan participation means such a greatly reduced plan administration load that most plans can be run—whether by an authorized provider or by plan sponsor personnel—via the 401(k) system on average in less than one hour per month.

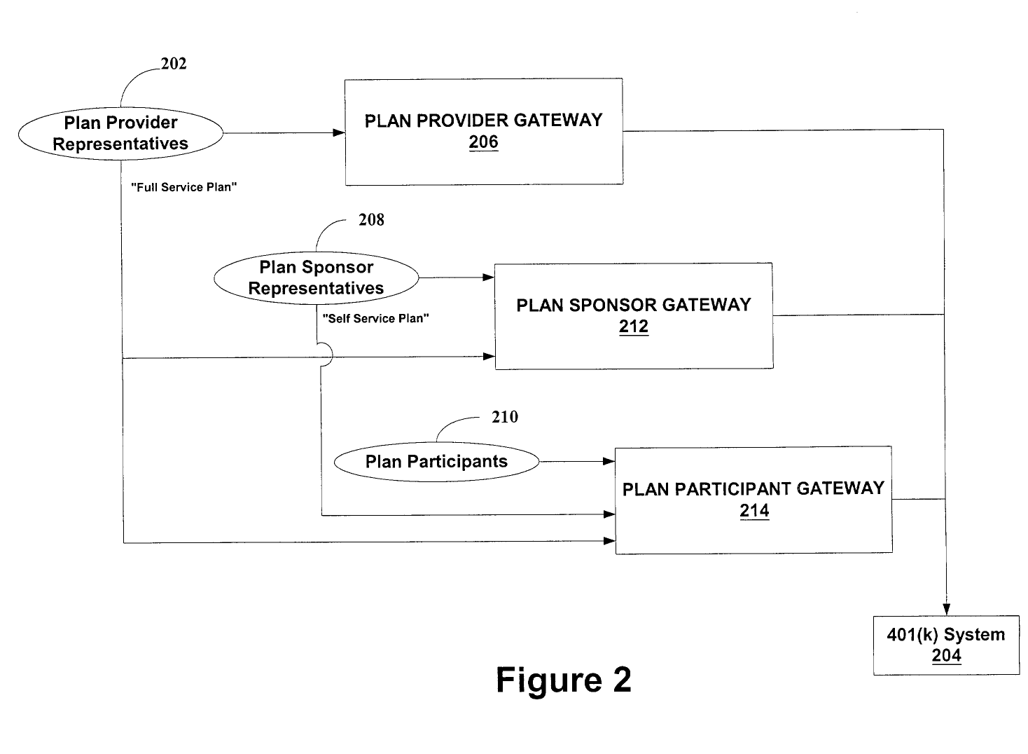

FIG. 2 summarizes the interaction between various entities and gateways. In a self-serve plan arrangement, the plan provider representatives 202 are able to access the 401(k) system 204 via the plan provider gateway 206. Similarly, plan sponsor representatives 208 and plan participants 210 are able to access the 401(k) system 204 via the plan sponsor gateway 212 and plan participant gateway 214 respectively. It should be noted that in the above-mentioned functionality, plan provider representatives 202 are able to additionally access both the plan sponsor gateway 212 and the plan participant gateway 214. Similarly, the plan sponsor representatives 210 are able to additionally access the plan participation gateway 214. The plan provider representatives 202 have hierarchical control over all gateways, and can activate and deactivate functions of the plan sponsor gateway 212 and the plan participant gateway 214 depending upon the configuration of functions that the client plan sponsor contracts for. In the case of self-serve configurations, the plan provider representatives 202 can enable the plan sponsor representatives 208 to perform a high percentage of plan maintenance and routine daily tasks involved in the operation of the plan, thereby reducing the plan provider representatives' workload. Likewise, the plan sponsor representatives 208 can enable the plan participants 210 to perform many self-serve functions, thus reducing the workload for the plan sponsor representatives 208.

In the case of a full-service plan, wherein the plan sponsor contracts to have the plan provider representatives 202 perform a high percentage (or all) of the operational and daily plan maintenance functions on behalf of the plan sponsor, the software can be configured by the plan provider representatives 202 in such a way as to disable many (or all) of the self-serve functions normally accessible to the plan sponsor representatives 208, and the plan participants 210.

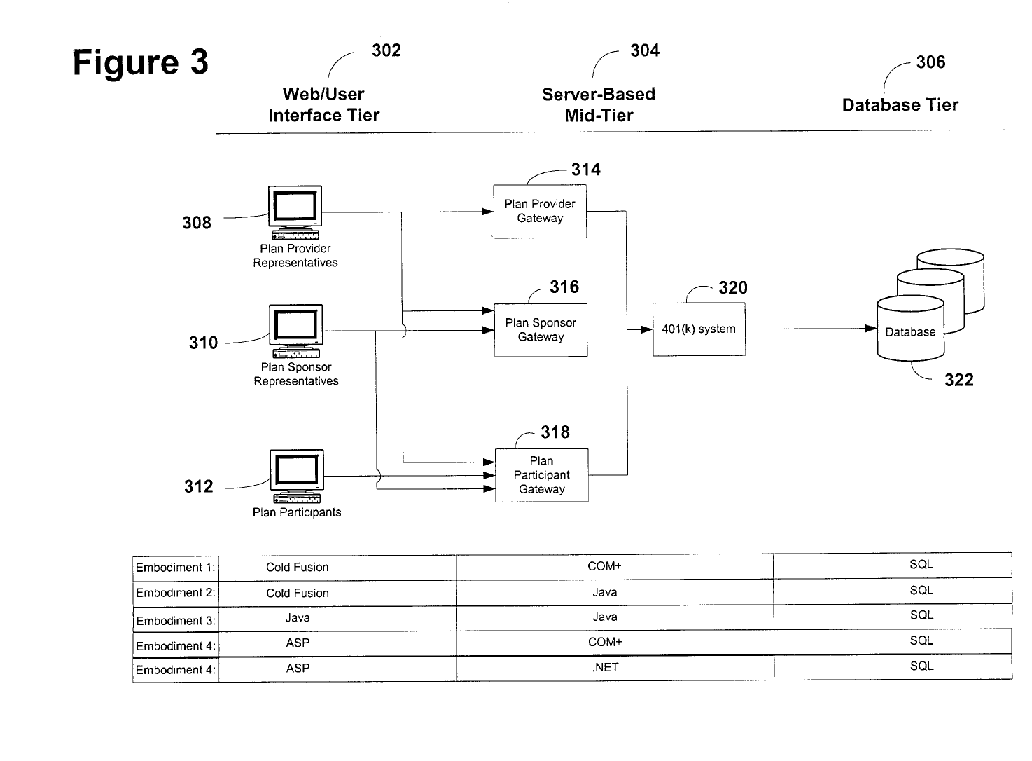

FIG. 3 illustrates a three-tier implementation (web/user interface tier 302, server-based mid-tier 304, and database tier 306) of a system based upon the present invention. In the web/user interface tier 302, plan provider representatives 308, plan sponsor representatives 310, and plan participants 312 use an interface to interact with a server-based mid tier comprising the present invention's gateways (i.e., plan provider gateway 314, plan sponsor gateway 316, and plan participant gateway 318) and 401(k) system as outlined in FIG. 2. The 401(k) system 320 in turn is operatively linked to the database tier 306.

In one embodiment, the web/user interface tier 302 is implemented using ColdFusion® and the server-based mid-tier 304 is implemented via COM+®. In a second embodiment, the web/user interface tier 302 is implemented using ColdFusion® and the server-based mid-tier 304 is implemented via Java®. In a third embodiment, both the web/user interface tier 302 and the server-based mid-tier 304 are implemented via Java. In a fourth embodiment, the web/user interface tier 302 is implemented via ASP and the mid-tier 304 is implemented using COM+. In a fifth embodiment, the web/user interface tier 302 is implemented using ASP and the mid-tier 304 is implemented using a .NET® architecture. In each of the above-mentioned three-tier embodiments, the database tier 306 can be implemented via an ODBC compliant database implementation such as a SQL server 322. It should be noted that in each of the embodiments the business logic is encapsulated in the server-based mid-tier 304. For example, the business logic can be encapsulated in the form of Enterprise Java Beans In an extended embodiment, the database tier 304 is behind a firewall, and the server-based mid-tier 304 and the database tier 306 are connected via an encrypted pathway, thereby provided an added level of security.

Customization Capabilities for the Plan Provider and the Plan Sponsor

The invention is customizable both on the system level (adaptable to the needs and corporate identity of the provider to whom it's licensed) and the individual plan level (adaptable to the needs of the individual plan sponsor and its employees).

The provider selects the name and color palette by which the invention will be presented to the public.

The provider sets the investments (proprietary or other, including self-directed brokerage accounts) to be available through the invention.

The provider establishes any fees it wants the present invention to bill clients, with fees being variable on a client-by-client, plan-by-plan, transaction-by-transaction basis.

The provider can choose to restrict or exclude any of the plan customization options available to clients.

There is no extra charge for including or excluding any options, a savings providers can easily pass on to clients.

The provider's clients use the plan setup wizard to choose the investments and plan options (eligibility parameters, automatic enrollment options, loan options, etc.) the provider has chosen to make available to plans on its system.

The licensed provider selects the name it wants its 401(k) system to bear to the public.

The provider selects the options it wants its licensed 401(k) system to offer 401(k) plan sponsors.

Each plan sponsor then selects from those options what it wants for its company plan.

System-Wide Customization Options

On the system level, the 401(k) software can be modified to include, exclude, or define, as applicable, the following:

The “look” of the plan provider's 401(k) system, including defining a specific web-safe palette of colors and/or by simply submitting the plan provider's logo to match the provider's main corporate website. These customization features enable the plan provider to select the name its 401(k) system will bear to the public.

The archival period (i.e., how long the system keeps data “live” before moving it to the “archived” fields) to be used within its licensed 401(k) system.

The investments to become available for the plan sponsor's plans. All investment types allowable by federal regulation for 401(k) investment are compatible with the 401(k) system, as are self-directed brokerage accounts.

Any minimum investment amounts or other investment restrictions to be applied (within those allowable by law).

Any fees and the definition thereof that plan sponsors will be charged—which can be posted to the plan sponsor's account via the 401(k) system on a client-by-client, plan-by-plan, even transaction-by-transaction basis, as applicable.

Each plan customization item listed below under individual plan customization options. Each item can be enabled or disabled on a plan-by-plan basis. The licensed provider's 401(k) system is customized to the above, with “exclude” items omitted completely from the system rather than dimmed out or otherwise disabled yet visible so that plan sponsors won't be distracted by why their provider doesn't offer a dimmed-out option.

Individual Plan Customization Options

A licensed 401(k) system provider's individual 401(k) plan sponsors has discretion over the following for each plan it adopts:

The plan's eligibility parameters, including age and length of service requirements, as well as residency status and exclusion of employees governed by a collective bargaining agreement.

Whether or not automatic enrollment will be activated and, if so, the default investment and contribution rate to be used.

The plan's investment options (from the list the provider has elected to offer, including self-directed brokerage accounts, if any).

Any employer-matching contributions to be offered.

Any employer profit-sharing contributions (a.k.a., discretionary contributions) to be offered.

Any employer-qualified non-elective contributions to be offered.

The vesting schedule(s) to be applied to any employer-matching and/or profit-sharing contributions being offered (qualified non-elective contributions are, by law, 100% vested when made).

Whether or not 401(k) loans will be allowed.

The plan year (or short plan years).

The payroll cycle on which processing will be run.

Plan administration and plan participation functions are customized to the above, with “exclude” items omitted completely rather than dimmed out or otherwise disabled yet visible so that eligible employees won't be distracted by why their company plan doesn't offer dimmed out items (such as particular investments or 401(k) loans, for instance).

End-User System Requirements

The basic end-user system requirement for using invention is merely Internet connectivity. That being met, there are basically no other barriers because the 401k system, though powerful, is represented to end-users in primarily simple HTML content (called “thin” content), which means:

The invention can be used via any type of Internet connection, including DSL, cable modem, ISDN, and even low-bandwidth dial-up connections.

The present invention functions well, even on the low-bandwidth dial-up connections, pages load in mere seconds.

The invention is designed to quickly connect and integrate with virtually all Voice Response Units (VRUs), wireless software applications, and application service providers (ASPs). The licensed plan provider selects the VRU and/or wireless solution best suited to its needs.

“Heavy” elements, such as Active® controls and JAVA® applets that can severely impact performance or bring it almost to a halt on low-bandwidth or dial-up connections, are abandoned in place of pure HTML to ensure top-quality performance and reliability.

The present invention uses simple HTML elements to their full advantage, delivering fully functional, intuitive user front-ends absent of “heavy” conflicts.

Most input validation is done on the plan sponsor side, greatly improving end-user performance and reducing traffic to and from the server.

The present invention's provides for context-sensitive help.

Server-Side System Requirements

The invention is virtually database-independent across most major SQL databases.

The invention is highly scalable, with the ability to run on a single server or across a cluster of multiple servers, as applicable.

Because the present invention delivers only simple HTML content to the end-users' browsers, there is never any access by outside parties to secure data residing on the server. The system does not store any sensitive data on the plan sponsor side; all data resides on the server side—because all key data and processing are handled by secure objects residing on the server, plan sponsor connections never have direct database access and are never provided with the location of databases or sensitive data.

New Plan Set-Up and Ongoing Maintenance

For the plan provider, the present invention brings speed and ease to setup and ongoing maintenance of clients' plans. The present invention's functionality is automated to the parameters chosen by the provider for the overall system and then further narrowed by each client's choices for its particular 401(k) plan.

The plan setup wizard assists new clients in setting up their 401(k) plans. The plan setup wizard explains all plan options (401(k) loans, investment options, employer contribution options and more) and records the client's decisions. Upon submission, the plan immediately appears within the plan provider gateway as “pending” and awaiting review/approval by the provider.

The system places only legally imposed limits, if any, on the number of qualified plans a single employer can sponsor.

The system places only legally imposed limits, if any, on the number of employees that can enroll in any particular plan.

Employees can participate in multiple plans simultaneously (within legal limits). The 401(k) system monitors each employee's activity on a per-plan and cumulative basis.

Self-service plan sponsor clients can add, update, and delete (more accurately, “disable from participation”) employee information themselves at any time through the plan sponsor gateway.

The present invention allows for flexible plan years, including short plan years, defined on a plan-by-plan basis.

The present invention allows for flexible payroll cycles defined on a plan-by-plan basis.

Plan sponsors define the investments they want to make available to plan participants from the spectrum of investments the provider has elected to offer, including proprietary investments and/or self-directed brokerage accounts.

The present invention automatically identifies highly compensated employees based on published parameters and integrates the information into its IRS compliance testing functions, which can be run in seconds and as often as the user (whether self-service employer personnel or full-service provider personnel) desires.

The present invention has a pre-defined import filter for initial import and setup of employee records.

The plan takeover and conversion wizard enables information to be imported during a plan takeover/conversion. The wizard allows for conversion of, among other categories: balances by source and fund; investment elections; year-to-date contributions (by source); year-to-date compensation; year-to-date hours; cumulative contributions; cumulative distributions; vested percentage by source; after-tax basis (frozen 88 and post 88 contributions); hardship basis (frozen 88 and post 88 contributions); life-to-date withdrawals and hardship-basis net of withdrawals; employee biographical information (including important dates); and pending loans (all necessary parameters).

The present invention gives provider personnel the option of enabling and disabling features and options available to clients on a plan-by-plan basis. Disabled features are completely invisible to end-users rather than dimmed or otherwise left visible but nonfunctioning so that clients and their employees are not distracted by features that aren't available in their particular plan.

The present invention gives the licensed provider the ability to define and post fees on a per client, per plan, per transaction basis.

Contribution Processing

The present invention grants licensed providers and their clients powerful yet easy-to-use contribution processing functions, including:

Six predefined contribution columns (money sources), three predefined loan payment columns, and four predefined compensation columns (profit sharing compensation, matching compensation, testing compensation, and 404c compensation) for regular processing.

The ability to process “special allocations” at any time for any money source. A built-in “matching calculator” to automatically calculate any employer-matching amounts based on matching compensation.

A built-in “profit sharing calculator” to automatically calculate any profit sharing amounts based on profit sharing compensation.

The ability to upload contribution, loan, and compensation data (using a predefined import file format) directly through the Web interface.

Validation checking with automatic generation of an error/exception report.

Flexible contribution system with the ability to do general contribution processing at any time.

The ability to process negative amounts (negative amounts do not automatically generate disbursements).

Contribution processing automatically held until money is deposited into a trust account and validated through a designated asset custodian, with manual override provided to plan provider personnel.

The ability to generate an export file to a trading platform and/or asset custodian system and to import and process trade confirmation information from that systems.

The storage of all necessary information for processed allocation records, including: PlanID, EmployeeID, FundID, TransactionID, LoanID (for loan related activity), NAV, source, as of or effective date, trade date, settlement date, amount, shares, and description.

Loan Processing

The present invention allows for up to three concurrent, independent loans per participant per plan.

The present invention automatically calculates available loan amounts.

Loans are set up using the following key criteria: principal amount, duration, interest rate, and payroll frequency.

Loan fees are included in APR calculation.

Loan payments are automatically allocated between principal and interest portions.

Normal repayments, negatives, partial payoffs, and complete payoffs can be accommodated.

Loan re-amortization is made based on changes in duration or pay frequency.

Loan delinquency reports are generated, with e-mail notifications sent to the plan administrator and the employee/participant.

Distribution and Transfer Processing

The present invention automatically calculates amounts available for distribution, taking into account pertinent factors such as outstanding loan amounts and vested account balances.

Transfer and distributions are limited by fund/source activity.

Spousal consent is determined by the plan administrator when approving distribution requests.

The present invention generates an export file for the asset trading platform and check writing systems (if applicable) and imports and processes trade confirmation information from those systems.

The present invention automatically processes residual distributions and transfers.

The present invention splits distributions with a portion as cash and a portion as a rollover, with the ability for the rollover portion to be processed independently of the cash portion.

The present invention automatically notifies the designated plan administrator (whether that person be employed by the plan sponsor or a licensed provider) via email of any hardship suspensions.

The present invention allows transfers in the form of $-to-$, %-to-%, $-to-%, and realignments. Transfers can be performed at the source level or for an entire account. If an account is “Pending Qualified Domestic Relations Order (QDRO)”, the system displays a warning flag during distribution, transfer, and loan activity.

Investment Income Processing

The system stores daily accrual and net asset value information and allocates income when actually received by the asset custodian.

Dividends/income are allocated as of a basis date (ex-date) and at the individual plan level.

The present invention automatically generates residual distributions and transfers for income posted after a full distribution or transfer.

The present invention automatically corrects income allocations for individual participants based on corrections or adjustments made “as of” a prior date. If a correction reduces an actual income allocation, extra income is redistributed pro-rata to remaining shareholders.

Creating and Communicating Fees

There is a flexible fee system through which providers bill their clients, with the ability for the licensed provider to automatically post fees defined per plan and per transaction. Providers have the ability to export fee and transaction information (for use by its fee-processing center, if any). Fee statements are automatically e-mailed to the plan sponsor after approved by provider personnel. Providers have the ability to automatically generate distributions to cover client fees and charges based on an algorithm defined in the present invention.

Administration Capabilities for the Plan Provider

The Invention's comprehensive self-service plan administration represents “hands-off” advantages for the licensed provider because the end-user client plan sponsor handles virtually all administrative duties itself from any location connected to the Internet.

Each client's plan sponsor gateway and all the plan administration functions and controls housed therein are automatically customized to the exact features and specifications of its 401(k) plan. For instance, if a client chooses not to offer 401k loans, no mention of 401(k) loans appears in the client's plan sponsor gateway (or plan participant gateway).

System customization includes the option for the licensed provider to have the invention require the provider's approval before designated self-service plan administration (and/or participation) activity(ies) can be enabled.

Self-service plan administration on the part of the plan sponsor is much more affordable, and thus particularly marketable to small businesses, which typically can run their 401(k) plans via the invention in less than one hour per month.

Self-service plan administration on the part of the plan sponsor is particularly marketable to small businesses because the self serve “run-it-yourself” approach moves certain administration recordkeeping functions from the hands of the off-site third party administrator to the direct hands-on control of the plan sponsor, resulting in significant savings, year after year. Plan sponsors who currently use a PC-based self-serve “run-it-yourself” plans (such as the 401(k) Easy™ plan) can save up to 90% yearly over the cost of traditional off-site third-party administration. A 100-person “run-it-yourself” 401(k) costs approximately $2,000 per year. This compares very favorably to the traditional “TPA-run” 401(k) plans, which range in price from approximately $11,000 per year to approximately $43,000 yearly (Source: Survey published in the US Department of Labor Study of 401(k) Plan Fees and Expenses, April 1998 (Section 4.3)).

Access is user-name and password protected enterprise-level security features and safeguards are standard throughout.

The licensed provider can observe, override, and suspend plan sponsor and/or plan participant activity at any time.

Self-service plan sponsor clients maintain their own company and employee records.

Self-service plan sponsor clients define their plan's investments from the selection the licensed provider has chosen to offer (then, within the plan participant gateway, plan participants designate the investments to which they want their 401(k) contributions directed and in what amounts).

Self-service plan sponsor clients process, approve, and administrate plan activity themselves, including contributions, distributions, transfers, and loans.

The invention generates activity reports, forms, and statements directly for the plan sponsor self-service clients and the plan participant self-serve users.

Self-service plan sponsor clients create and edit their own bulletins for display on plan participants' login pages.

Self-service plan sponsor clients cue the invention to run IRS compliance tests whenever desired. Possible tests include 402(g), 401(k), 401(m), 415, multiple use tests, top heavy tests, coverage tests, and compensation tests. The invention “knows” which tests are applicable to any given 401(k) plan based on encoded criteria.

The invention's comprehensive compliance wizard calculates compliance test correction solutions for the plan sponsor (or plan provider, if applicable), at a few clicks of a mouse, based on prevailing federal regulations.

“Full-Service” Administration Capabilities for the Plan Provider

On a plan-by-plan basis, the invention gives licensed providers the option of having authorized provider personnel handle 401(k) administrative duties for clients as an alternative to the self-service option.

In such full-service plans, the invention's plan administration functions can be hidden within the plan sponsor gateway to any degree desired. For instance, the provider and client might choose to keep certain data submission functions accessible to the client but have all processing, report, and participant statement generation, participant request review, etc, functions invisible to the plan sponsor and visible to and operational by authorized provider personnel only.

The invention's extremely flexible client billing system makes it easy for the provider to set variable prices for each plan and charge each client plan sponsor for exactly the services rendered to the sponsor's company, making it possible to accurately bill for varied service levels of plan administration.

The invention's plan administration—whether operated by plan sponsor or provider personnel—is highly automated, plan-specific and designed to be operable by even the most 401(k)-uninitiated, allowing the provider to keep labor costs down even in full-service 401(k) administration situations.

Self-Service for Plan Participants

On-line plan participation affords a “hands-off” advantage for the provider, minimal work for the plan sponsor (whether the plan sponsor or provider personnel), and convenience for plan participants.

The provider can remain completely out of day-to-day plan operations and participation activity, yet they have the freedom to monitor and/or get involved in activity at any time.

System and per-plan customization includes the option for the licensed provider (and, if so designated, the plan sponsor) to have the invention require provider and/or plan sponsor approval before any so-designated self-service plan participation activity(ies) can be implemented. The invention then automatically notifies the relevant party(ies) immediately regarding relevant activity via both internal and external e-mail messaging.

Self-service clients' plan administration workload is greatly diminished from what a client might at first anticipate, because plan participants “help themselves” to enrolling in the plan online. Employee plan participants also update their own personal information and investment designations; review and print activity reports and account statements: and model and/or submit 401(k) loans, transfer and distribution requests, and more. The invention immediately notifies the relevant party via e-mail of all relevant transaction requests and account activity designated as requiring that party's approval.

Plan participants never have to involve the plan sponsor or company's human resources personnel (or the plan provider) with routine account information updates. Instead, plan participants update personal information themselves, on-line, in private, at their leisure and convenience. Participants can amend their address, telephone number(s), disbursement preferences, passwords, and more. The 401(k) system immediately notifies the plan administrator via e-mail of any changes, and all approved updates are instantaneously available system-wide.

Universal Access

All persons involved in the 401(k) plan, be they plan provider, plan sponsor, or plan participant, can use the present invention if they have access to the Internet. The present invention is accessible from PC, Macintosh, Unix and Kiosk computers, and is accessible via any of today's popular web browsers, including Internet Explorer®, Netscape®, and AOL®.

The present invention is fully operational 24 hours a day, seven days a week. Providers and their clients can not only view and submit data at any time, but the present invention instantaneously processes all requests and submissions regardless of the time of day or day of the week. The present invention is highly automated and customized to both the licensed provider's specifications and each of provider's 401(k) clients, making it easily useable by even the most 401(k) uninitiated. Sensitive data resides on the server-side, and all admittance to activity is user name- and password-protected to keep all data and operations “iron-clad” secured.

The present invention is designed to quickly connect and integrate with virtually all Voice Response Units (VRUs), wireless software applications, and application service providers (ASPs). The licensed provider selects the VRU and/or wireless solution best suited to its needs.

On-Line Help System

The present invention's on-line help system enables the plan provider, plan sponsor, and plan participant to receive context-sensitive help from any screen image, at any time, at the click of a mouse. The present invention's “Help” function opens up to the section pertaining to the section of the invention from which the user clicked on the “Help” icon, with links to related topics as well as an index. Neither plan sponsors nor individual plan participants need ever involve the licensed provider with questions about how to use the present invention, increasing customer satisfaction and further reducing overhead the provider might otherwise experience. Included in on-line help is a definition of 401(k) terms and features, as well as operational help.

Database Independence

Because the present invention has been developed in Java, it is database-independent across most major SQL databases, including Oracle, SQL Server, DB2, and Sybase. Business rules are encapsulated within server-side objects residing on the server, eliminating the need for database-specific structures such as triggers, stored procedures, and cascading relationships.

Scalability and Security

The present invention is highly scalable and can be run on a single server or across a cluster of multiple servers, as appropriate. The present invention can service anywhere from one to an unlimited number of eligible employees dispersed among an unlimited number of plans and plans per plan sponsor client.

Because the invention delivers only simple HTML content to browsers, there is never any access by outside parties to secure data residing on the server. The system does not store any sensitive data on the client side; all data resides on the server side. All key data and processing are handled by secure objects residing on the server. Client connections never have direct access to the plan provider's database and are never provided with the location of databases or sensitive data.

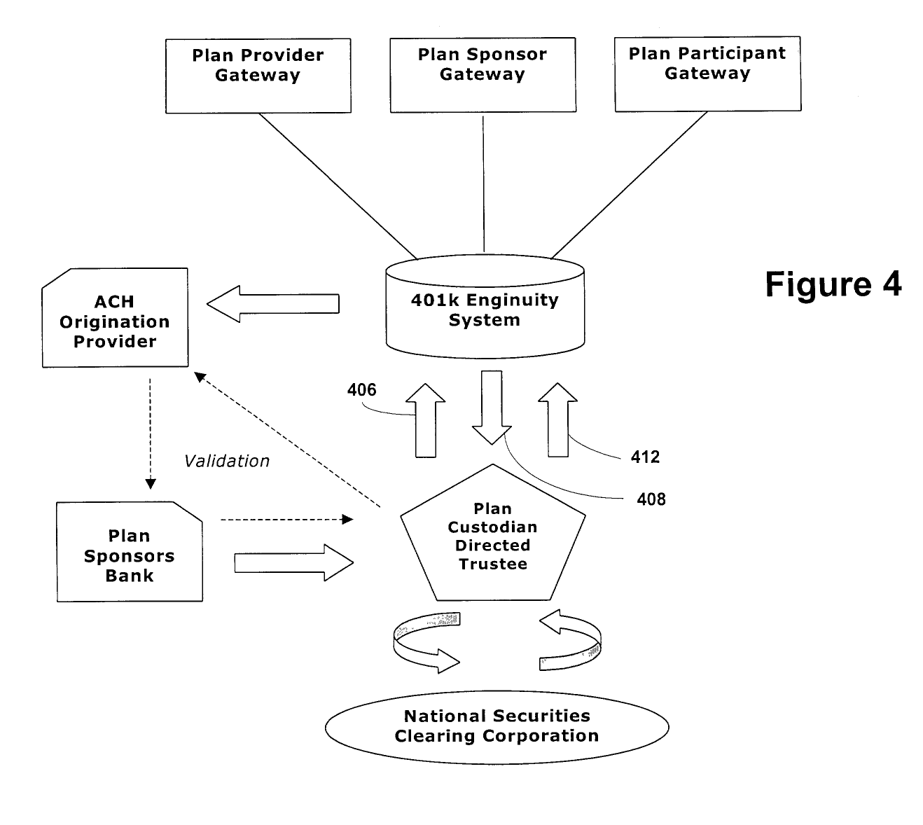

FIG. 4 illustrates a flowchart showing the routine sequence of events and flow of the present invention's 401(k) system. Thus, FIG. 4 illustrates a systematic approach for moving salary deferral dollars from the checking account of the plan sponsor into the plan trust account (or the plan custodian/director trustee). There are a variety of ACH origination providers for clearing money transactions through electronic funds transfers. ACHs are nonprofit organizations that all banks (or other financial institutions or any individual institution) use to move money electronically. So, the ACH monitors electronics funds for clearing and settlement purposes. Thus, just like the New York Stock Exchange is for stocks, the ACH is for cash (and the ACH helps move the money).

The 401(k) system generates an ACH (Automatic Clearing House) request (402) for the amount of money necessary to pay for a plan's pending purchase transactions (404). The ACH intermediary system validates the request, including the validity of the party receiving the money, the party sending the money, the location of the money, the amounts, routing path, routing numbers and ABA numbers of the parties involved in the transaction, and deploys other security measures. In the case of ACH requests initiated by the 401(k) system, the money discussed in this invention is primarily comprised of plan participants' monthly retirement savings contributions, participants' 401(k) loan repayments, participants' IRA rollovers, and trust-to-trust, or plan-to-plan transfer of assets.

The 401(k) system requests are sent via ACH to the plan asset custodian(s) (examples of asset custodians include Charles Schwab & Company®, Fidelity®, First Trust®, etc.) in the form of an electronic funds transfers (EFT). In the preferred embodiment, the 401(k) system never receives constructive receipt of any cash, stock or bonds, or mutual fund shares.

An electronic confirmation that the ACH-arranged transaction between the “sender” (i.e. the bank holding participants' 401(k) contributions) and the “receiver” (one or more plan asset custodians used by the plan provider) is sent to the 401(k) system (406). This confirmation is sent to the 401(k) system by the asset custodian(s) that received the money previously requested be sent to them by the 401(k) system. The confirmation that the money is under the control of the requisite asset custodian(s) essentially triggers the next step in the process which is alerting the plan provider to use the 401(k) system to first. The notification is used by the 401(k) system to alert the plan provider (408) that the next step in the process can proceed. The next step is the 401(k) system, under the direction of the plan provider, will aggregate all pending investment buy and sell transactions for all plans on the provider's system, and once aggregated, send one or more trade files to the asset custodian(s) for processing, with the sure knowledge that the money needed to support the transactions is “on-site” with the asset custodian(s) and ready to be used.

Upon receiving the trade files from the plan provider's 401(k) system, the asset custodian(s) are able to clear and settle the trades through interaction with the National Securities Clearing Corporation (NSCC) (410). The asset custodian(s) then confirms all transactions back to the 401(k) system (412) along with files that report updated investment balances and updated share pricing of mutual funds or other investments. The updated balances and pricing are used by the 401(k) system to update the values and holdings of all plan participants, across all plans maintained by the plan providers system. In the event the plan asset custodian encounters any trading errors or other transaction problems, these problems are promptly reported back to the 401(k) system to be addressed by the plan provider.

Using the information received from the asset custodian after all trades have been settled at the NSCC level, the 401(k) system updates all records with new share pricing, and allocates updated earnings and losses for all plan participant records on the system. Any errors that are reported to the 401(k) system by the asset custodian(s) are resolved by the plan provider, using features and controls built within the 401(k) system.

Plan asset custodians can also be referred to as custodian “directed-trustees.” Like the plan asset custodian, the custodian directed trustee maintains physical or custodian possession of plan assets, but in addition to asset custody, the directed trustee assumes additional responsibilities to their clients. These additional responsibilities include keeping plan assets in segregated accounts, assuming more liability for clients' assets, providing additional accounting and comprehensive auditing services to their clients' plans, and acting upon instructions of both plan providers and in some cases plan sponsors. Directed trustees are fiduciaries of plan assets, which signifies a higher level of responsibility and liability than that of the asset custodian.

### CONCLUSION

A system and method has been shown in the above embodiments for the effective implementation of a web-based management of retirement funds via a gateway architecture. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific computing hardware.

The above enhancements for icons and its described functional elements are implemented in various computing environments. For example, the present invention may be implemented on a conventional mainframe or equivalent, multi-nodal system (e.g., LAN), or networking system (e.g., Internet, WWW, wireless web). All programming, GUIs, display panels and dialog box templates, and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of Java and object-oriented programming.

1. A web-based system for real-time management of retirement funds, said system comprising:
a. a computer-based retirement funds management system managing retirement funds associated with one or more participants;
b. a plan provider gateway accessing said computer-based retirement funds management system and performing any of, or a combination of, the following tasks: approving and modifying settings associated with said participants, approving and modifying plan settings associated with said participants, maintaining a range of investments, and processing and distributing investment income and dividends;
c. a plan sponsor gateway accessing said computer-based retirement funds management system and performing any of, or a combination of, the following tasks: configuring clients, configuring bulletins, configuring divisions, configuring information associated with said participants, viewing and editing plans, displaying a list of plan participants, displaying investments within a selected plan, performance compliance testing, and processing participant contributions; and
d. a plan participant gateway accessing said computer-based retirement funds management system and performing any of, or a combination of, the following tasks: updating information associated with said participants, updating investment designations, and monitoring, modeling and applying for loans, transfers, and distribution.

2. A web-based system for real-time management of retirement funds, as per claim 1, wherein said retirement funds are funds associated any of the following plans: 401(k) plans, money purchase plans, or profit sharing plans.

3. A web-based system for real-time management of retirement funds, as per claim 1, wherein said computer-based retirement funds management system is operatively linked with one or more databases storing participant related information.

4. A web-based system for real-time management of retirement funds, as per claim 3, wherein said databases are implemented via: Oracle, SQL, DB2, or Sybase.

5. A web-based system for real-time management of retirement funds, as per claim 1, wherein said participant related information is any of the following: retirement plan identification information, employee identification information, funds identification information, transaction identification information, loan identification information, trade data, source information, settlement data, amount, shares, description of shares, net asset value information, or as-of- or effective-date.

6. A web-based system for real-time management of retirement funds, as per claim 1, wherein said compliance testing is for any of, or a combination of, the following tests: 402(g), 401(k), 401(m), 415, multiple use test, top heavy test, coverage test, and compensation test.

7. A web-based system for real-time management of retirement funds, as per claim 1, wherein said system is implemented via any of the following architectures: a Java-based architecture, a COM+ architecture, or a .Net architecture.

8. A web-based system for the management of retirement funds, said system comprising:
a. a computer-based retirement funds management system managing retirement funds associated with one or more plan providers, one or more authorized plan provider representatives, one or more plan sponsors, one or more authorized plan sponsor representatives, and one or more plan participants;
b. a plan provider gateway providing said one or more plan providers and said one or more authorized plan provider representatives with access to said computer-based retirement funds management system;
c. a plan sponsor gateway providing said one or more plan sponsors, said one or more authorized plan sponsor representatives, and said one or more authorized plan provider representatives with access to the computer-based retirement funds management system; and
d. a plan participant gateway providing said one or more plan participants, said one or more authorized plan sponsor representatives, and said one or more authorized plan provider representatives with access to the computer-based retirement funds management system,
whereby, in a full service mode, said plan providers and said one or more authorized plan provider representatives have additional access to said plan sponsor gateway and plan participant gateway, and in a self service more, said plan sponsors and said one or more authorized plan sponsor representatives have additional access to said plan participant gateway.

9. A web-based system for the management of retirement funds, as per claim 7, wherein said plan providers comprises any of the following entities: banks, brokerages, insurance companies, or payroll services.

10. A web-based system for the management of retirement funds, as per claim 8, wherein said retirement funds are funds associated any of the following plans: 401(k) plans, money purchase plans, or profit sharing plans.

11. A web-based system for the management of retirement funds, as per claim 8, wherein said computer-based retirement funds management system provides said one or more plan providers and said one or more plan sponsors with user-defined data archival periods defining the number of days data related to said retirement funds is to be held before archiving in one or more databases.

12. A web-based system for the management of retirement funds, as per claim 11, wherein said databases are implemented via: Oracle, SQL, DB2, or Sybase.

13. A web-based system for the management of retirement funds, as per claim 11, wherein said database stores any of the following information: retirement plan identification information, employee identification information, funds identification information, transaction identification information, loan identification information, trade data, source information, settlement data, amount, shares, description of shares, net asset value information, or as-of- or effective-date.

14. A web-based system for the management of retirement funds, as per claim 8, wherein said system provides a detailed audit trail of all changes made to said database including the date and time a change was made, the user who entered the change, the effect of the change, and the type of change made.

15. A web-based system for the management of retirement funds, as per claim 8, wherein said plan sponsor gateway allows said one or more plan sponsors the ability to perform any of the following compliance tests: 402(g), 401(k), 401(m), 415, multiple use test, top heavy test, coverage test, and compensation test.

16. A web-based system for the management of retirement funds, as per claim 8, wherein said computer-based retirement funds management system further comprises a matching calculator to automatically calculate an employer's matching amount based upon their matching compensation.

17. A web-based system for the management of retirement funds, as per claim 8, wherein said computer-based retirement funds management system further comprises a profit sharing calculator to calculate profit sharing amounts based upon profit sharing compensation.

18. A web-based system for the management of retirement funds, as per claim 8, wherein said plan participant gateway allows said one or more plan participants to model and accept loans, distributions, and transfers.

19. A web-based system for the management of retirement funds, as per claim 8, wherein said system is implemented via any of the following architectures: a Java-based architecture, a COM+ architecture, or a Net architecture.

20. A web-based system for the management of retirement funds, as per claim 8, wherein said system further comprises reconciliation tools for reconciliation with an external trust system and produce variance/exception reports.

21. A web-based system for the management of retirement funds as per claim 8, wherein said web-based system communicates with said one or more plan providers, one or more plan sponsors, and one or more plan participants via data in HTML format.

22. A web-based system for the management of retirement funds, said system comprising:
a. one or more databases;
b. a computer-based retirement funds management system operatively linked with said one or more databases storing retirement fund/plan information associated with one or more plan providers, one or more plan sponsors and one or more plan participants;
c. a plan provider gateway providing said one or more plan providers with access to said computer-based retirement funds management system;
d. a plan sponsor gateway providing said one or more plan sponsors with access to the computer-based retirement funds management system; and
e. a plan participant gateway providing said one or more plan participants with access to the computer-based retirement funds management system.

23. A web-based system for the management of retirement funds, as per claim 22, wherein said one or more databases are implemented via: Oracle, SQL, DB2, or Sybase.

24. A web-based system for the management of retirement funds, as per claim 22, wherein said retirement fund/plan information comprises any of the following information: retirement plan identification information, employee identification information, funds identification information, transaction identification information, loan identification information, trade data, source information, settlement data, amount, shares, description of shares, net asset value information, or as-of- or effective-date.

25. A web-based system for the management of retirement funds, as per claim 22, wherein said plan providers comprises any of the following entities: banks, brokerages, insurance companies, or payroll services.

26. A web-based system for the management of retirement funds, as per claim 22, wherein said plan sponsor gateway allows said one or more plan sponsors the ability to perform any of the following compliance tests: 402(g), 401(k), 401(m), 415, multiple use test, top heavy test, coverage test, and compensation test.

27. A web-based system for the management of retirement funds, as per claim 22, wherein said plan participant gateway allows said one or more plan participants to model and accept loans, distributions, and transfers.

28. A web-based system for the management of retirement funds, as per claim 22, wherein said system is implemented via any of the following architectures: a Java-based architecture, a COM+ architecture, or a Net architecture.

29. A web-based system for the management of retirement funds as per claim 22, wherein said web-based system communicates with said one or more plan providers, one or more plan sponsors, and one or more plan participants via data in HTML format.

30. A web-based system for the management of retirement funds as per claim 22, whereby, in a full service mode, said plan providers have additional access to said plan sponsor gateway and plan participant gateway, and in a self service more, said plan sponsors have additional access to said plan participant gateway.
